(19) United States
(12) Patent Application Publication
(10) Pub. No.: US 2005/0025165 A1
(43) Pub. Date: Feb. 3, 2005

(54) System and method for assigning IP address in ethernet passive optical network

(76) Inventors: Min-Hyo Lee, Suwon-si (KR); Young-Seok Kim, Seongnam-si (KR); Yun-Je Oh, Yongin-si (KR); Tae-Sung Park, Yongin-si (KR)

Correspondence Address: CHA & REITER, LLC, 210 ROUTE 4 EAST STE 103, PARAMUS, NJ, 07652, US

(21) Appl. No.: 10/825,814

(22) Filed: Apr. 16, 2004

(30) Foreign Application Priority Data
Jul. 30, 2003 (KR) 2003-52805

(51) Int. Cl. H04L 12/28

(52) U.S. Cl. 370/401; 370/392

(57) ABSTRACT

A system and method for assigning IP addresses in an Ethernet passive optical network which includes one OLT (Optical Line Terminal) and a plurality of ONTs (Optical Network Terminals) connected to the OLT are disclosed. The method includes the steps of including a dynamic host configuration protocol (DHCP) server in the OLT, establishing IP address pools including at least one IP address according to the ONTs, and searching for an ONT from a MAC processing section of the OLT by means of a MAC address from which IP address assignment is requested when IP address assignment is requested from one of the ONTs. The ONT is connected to a DHCP client. The DHCP server assigns an available IP address existing in an IP address pool established for the ONT having requested the IP address assignment according to ONTs.

### CLAIM OF PRIORITY

This application claims priority to an application entitled “Method for assigning IP address in Ethernet passive optical networks,” filed in the Korean Intellectual Property Office on Jul. 30, 2003 and assigned Serial No. 2003-52805, the contents of which are hereby incorporated by reference.

### BACKGROUND OF THE INVENTION

1. Field of the Invention

The present invention relates to a system and method for assigning dynamic IP (Internet Protocol) addresses in an Ethernet passive optical network (hereinafter, referred to as “EPON”) that includes, for example, one optical line terminal (hereinafter, referred to as “OLT”) and a plurality of optical network terminal (hereinafter, referred to as “ONT”).

2. Description of the Related Art

Conventional passive optical networks (hereinafter, referred to as “PON”) have a point-to-multipoint network configuration in which a plurality of ONTs share an OLT through an optical fiber.

From among the various types of PONs, an asynchronous transfer mode passive optical network (hereinafter refer to as “ATM-PON”) was developed first. Then came the EPON and a gigabit Ethernet passive optical network (hereinafter refer to as a “GE-PON”) have been developed and are being standardized in the International Telecommunication Union-Telecommunication (ITU-T) section.

In such PONs, in order to assign IP addresses to hosts for respective subscribers, a dynamic host configuration protocol (hereinafter, referred to as “DHCP”) can be used. As well known in the art, the DHCP is a service that is used to configure a TCP/IP environment with a dynamic IP to eliminate inconvenience of mobile users and wasteful elements in management, which may be incurred when the TCP/IP environment is configured with a static IP. According to DHCP, dynamic IP addresses of clients are automatically configured to more easily manage IP addresses.

Hereinafter, an example of assigning dynamic IP addresses by using the DHCP in a PON will be described.

FIG. 1 is a block diagram of an EPON including DHCP servers. As shown in FIG. 1, an OLT1 20 and an OLT2 22 are connected to a plurality of ONTs 30, 32 to 34, and 36 to 38. The OLT1 20 and the OLT2 22 are located in a route of a tree structure and performs a central role in providing information to each subscriber of an access network. Downstream data signals transmitted from the OLT1 20 and the OLT2 22 are distributed to the ONTs 30, 32 to 34, and 36 to 38, while upstream data signals transmitted from the ONTs 30, 32 to 34, and 36 to 38 are multiplexed by a time division multiplexing (TDM) method and transmitted to the OLT1 20 and OLT2 22.

The ONTs 30, 32 to 34, and 36 to 38 receive the downstream data signals and provide them to end users. The ONTs 30, 32 to 34, and 36 to 38 also transmit data output from the end users to respective corresponding OLT1 20 and OLT2 22 as an upstream data signal of a variable length. Coupled to the OLT1 20 and the OLT2 22 are first and second DHCP servers 10 and 12 that are used to assign dynamic IP addresses. The first and second DHCP servers 10 and 12 use a lease generation process to assign an IP address to a client for a predetermined period of time. In general, since IP addresses are temporarily leased, a DHDP client must periodically renew the lease by using the first and second DHCP servers 10 and 12. In the EPON, the ONTs 30 to 38 are DHCP clients of the first and second DHCP servers 10. The DHCP servers 10 and 12 assign IP addresses to the respective ONTs 30 to 38, but the IP addresses are actually assigned to a plurality of end users connected with the respective ONTs 30 to 38.

FIG. 2 is a diagram explaining a method of assigning a dynamic IP address in the EPON including DHCP servers. In FIG. 2, it is assumed that the ONT4 36 requests assignment of an IP address as a DHCP client and both the first and the second DHCP servers 10 and 12 respond to the request for assignment of an IP address.

First, in step 50, the ONT4 36, which is a DHCP client that wants an IP address assignment, broadcasts an IP lease request to the DHCP servers by means of a DHCP discovery message. The ONT4 36 broadcasts a request message for a location of a DHCP server and IP address information. At this time, the ONT4 36 assigns a null IP address in the DHCP discovery message to communicate with a DHCP server, and outputs the DHCP discovery message with its own hardware MAC (Media Access Control) address and host name. Subsequently, in step 52, the first and the second DHCP server 10 and 12 receive the broadcasted request message, assign an IP address to be provided to the DHCP client, and responds with an IP lease offer message. The IP lease offer message includes the hardware MAC address of the client, a term of lease of the assigned IP address, and a server identifier (an IP address of a DHCP server). The IP lease offer message is also broadcasted because an IP address is not yet assigned to the ONT4 36, which is a client. Therefore, the ONT4 36, the client, requesting an IP address assignment, receives IP lease offer messages from both of the first and second DHCP server 10 and 12, and selects the IP lease offer message which arrives first. Next, the ONT4 36, which is a DHCP client, responds with an IP lease selection message to the servers in step 56, in which case also a broadcasting method is used. This is necessary because all DHCP servers must be notified that an IP address has been assigned so as to prevent double IP addresses from being assigned. The IP lease selection message includes the server identifier (the IP address of a DHCP server) and an IP address to be used by the client.

The first DHCP server 10 having received the IP lease selection message broadcasts an IP lease acknowledgment message to the client. In this case, since there is no IP address assigned to the client yet, the broadcasting method is used. In step 60, when the ONT4 36 sends an acknowledgment response signal to the first DHCP server 10, the ONT4 36 is regarded as a bound DHCP client, so that it is possible to communicate by means of TCP/IP.

However, since a DHCP server is connected to an ONT through an OLT as shown in FIG. 1 when the DHCP server assigns an IP address to a subscriber host by means of a DHCP in the EPON, the DHCP server cannot determine the ONT, subscriber hosts of which request IP address assignment, so that the DHCP server cannot control IP address assignment according to ONTs. Because of this problem, a method of setting Ethernet MAC addresses of the subscriber hosts in the DHCP server and assigning an IP address to only the set hosts must be used, but an operator of the DHCP server must register MAC addresses for respective subscriber hosts one by one.

### SUMMARY OF THE INVENTION

One aspect of the present invention is to provide a method for assigning IP addresses in which it is possible to control IP address assignment to subscriber hosts according to ONTs.

Another aspect of the present invention is to provide a method for assigning IP addresses in which the IP addresses can be efficiently assigned to subscriber hosts according to ONTs.

One embodiment of the present invention is directed to a method for assigning IP addresses in an Ethernet passive optical network that includes one OLT (Optical Line Terminal) and a plurality of ONTs (Optical Network Terminals) connected to the OLT. The method includes the steps of including a dynamic host configuration protocol (DHCP) server in the OLT, establishing IP address pools including at least one IP address according to the ONTs, and searching for an ONT from a MAC processing section of the OLT by means of a MAC address from which IP address assignment is requested when IP address assignment is requested from one of the ONTs. The ONT is connected to a DHCP client and the DHCP server assigns an available IP address existing in an IP address pool established for the ONT having requested the IP address assignment according to ONTs.

Another embodiment of the present invention is directed to an OLT (Optical Line Terminal) that is connectable to a plurality of ONTs (Optical Network Terminals) in an Ethernet passive optical network. The OLT includes a dynamic host configuration protocol (DHCP) server, a communication interface to the plurality of ONTs, and a MAC processing section. The DHCP server is configured to search for an ONT from the MAC processing section using a MAC address from which an IP address assignment is requested when IP address assignment is requested from one of the plurality of ONTs through the communication interface.

### BRIEF DESCRIPTION OF THE DRAWINGS

The above features and advantages of the present invention will be more apparent from the following detailed description taken in conjunction with the accompanying drawings, in which:

FIG. 1 is a block diagram of an EPON including DHCP servers;

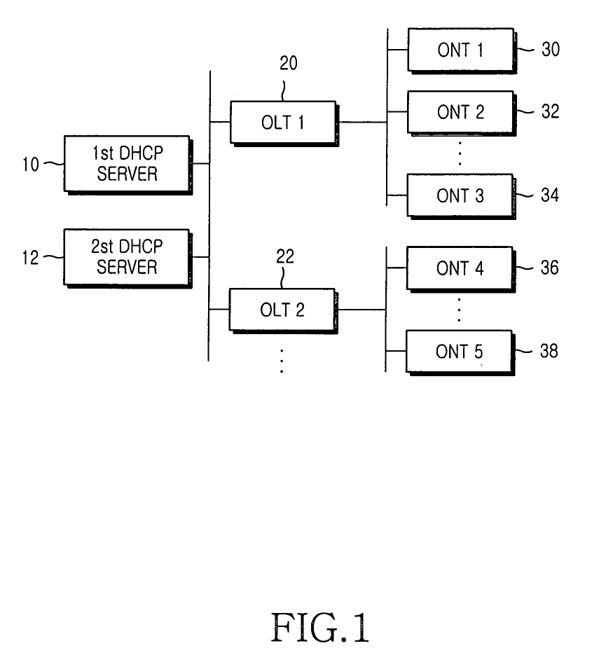

FIG. 2 is a diagram explaining a method of assigning a dynamic IP address in an EPON including the DHCP servers;

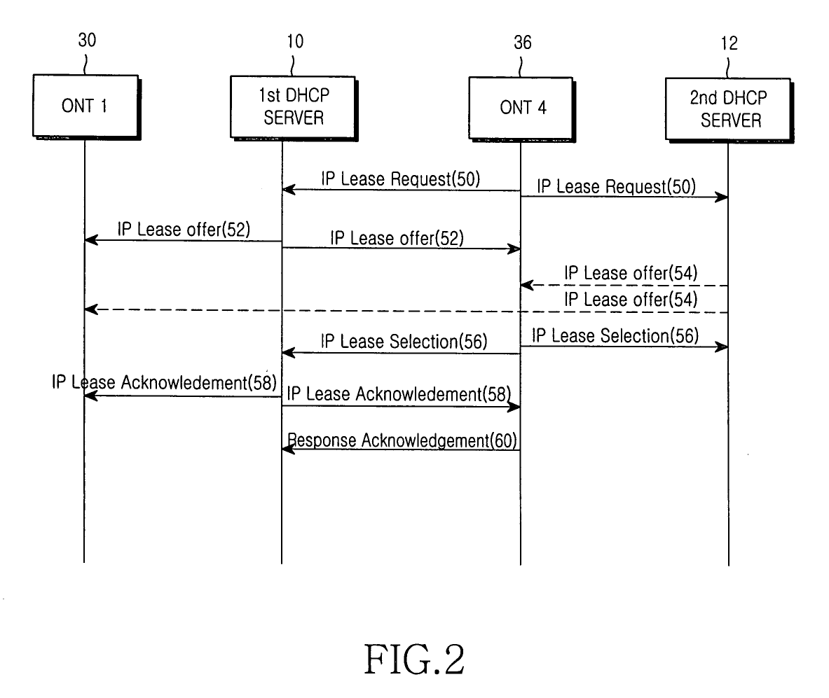

FIG. 3 is a block diagram illustrating an EPON which includes an OLT having an DHCP server according to an embodiment of the present invention; and

FIG. 4 is a diagram explaining a method of assigning a dynamic IP address in an EPON according to an embodiment of the present invention.

### DETAILED DESCRIPTION

Hereinafter, one embodiment of a method for assigning IP (Internet Protocol) addresses in an EPON (Ethernet Passive Optical Network) will be described with reference to the accompanying drawings. For the purposes of clarity and simplicity, a detailed description of known functions and configurations incorporated herein will be omitted when it may obscure the subject matter of the present invention.

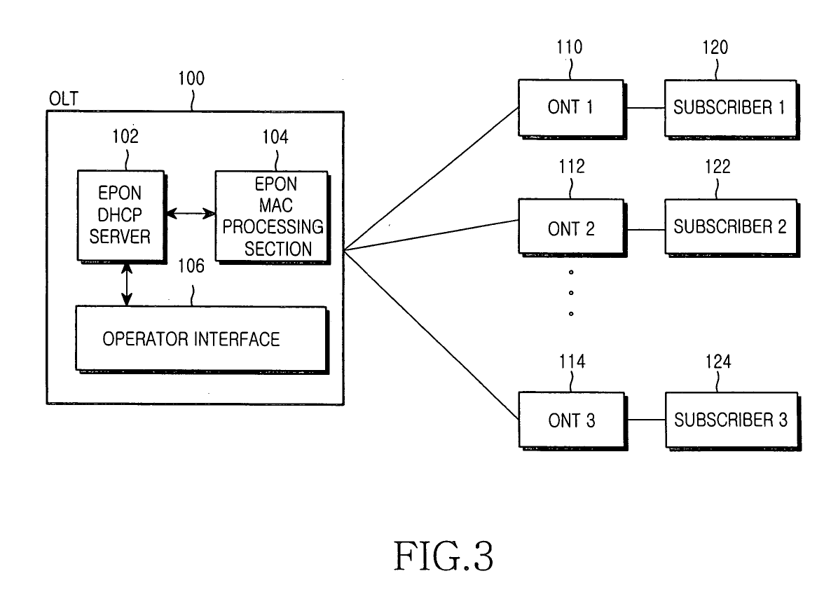

FIG. 3 is a block diagram illustrating an EPON which includes an OLT (Optical Line Terminal) having a DHCP (Dynamic Host Configuration Protocol) server according to one embodiment of the present invention. As shown in FIG. 3, according to this embodiment, a DHCP server 102 is contained in an OLT 100 and is configured to assign IP addresses to subscribers of respective ONTs (Optical Network Terminals). The DHCP server 102 cooperates with a MAC (Media Access Control) processing section 104 in the OLT 100. When each subscriber of an ONT requests IP address assignment, the DHCP server 102 searches for an ONT in which a DHCP host is located from the MAC processing section 104, using a hardware MAC address of the subscriber having requested IP address assignment as an index. The MAC processing section 104 is a component which performs a function necessary for Ethernet MAC, and includes host MAC address information according to ONTs. In the conventional EPON, a DHCP server cannot detect the ONT which includes a DHCP client requesting IP address assignment. In contrast, in the EPON according to this embodiment of the prevent invention, since the DHCP server 102 is contained in the OLT 100, the DHCP server 102 can use information of each ONT which the OLT 100 has, so that it is unnecessary to use a broadcasting method in an IP address assignment process.

IP addresses that the DHCP server 102 assigns to respective subscribers are selected by an operator from respective IP address pools established according to the ONTs in which each subscriber is included. Each IP address pool is a range of available IP addresses which can be used for lease or assignment to subscribers of each ONT. The operator can establish an IP address pool having a predetermined number of IP addresses according to the ONTs by means of an operator interface 106.

According to another embodiment, the DHCP server 102 may establish an IP address pool according to the ONTs when the operator orders it through the operator interface 106 that respective IP address pool are established. According to the EPON, when an ONT subscriber requests IP address assignment, the DHCP server 102 confirms a state of an IP address pool of the ONT itself. If there is an available IP address in the IP address pool, the DHCP server 102 selects the available IP address from the IP address pool and provides the selected IP address to the ONT subscriber having requested IP address assignment.

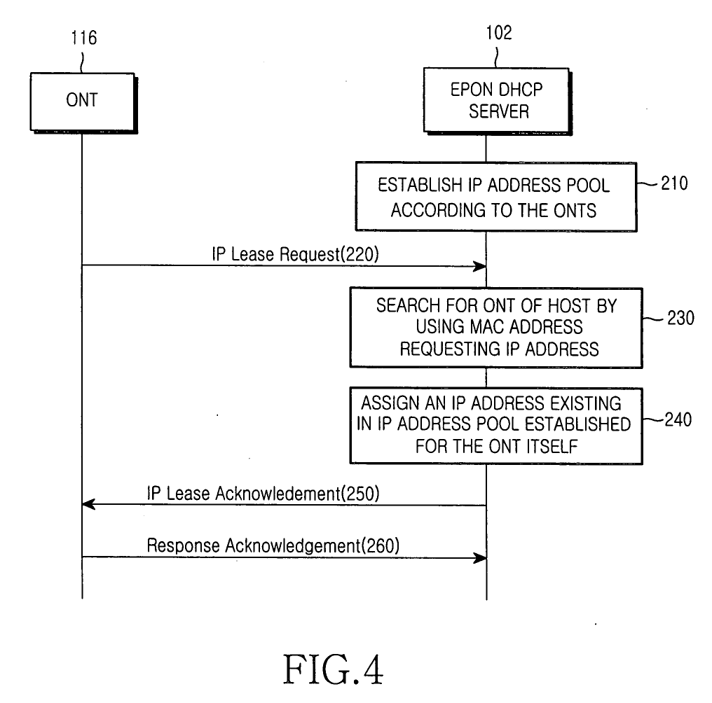

Hereinafter, a method of assigning an IP address from such a DHCP server to an ONT will be described with reference to FIG. 4.

FIG. 4 is a diagram explaining a method of assigning a dynamic IP address according to another embodiment of the present invention. As shown in FIG. 4, in step 210, the EPON DHCP server 102 establishes IP address pools according to the ONTs. An IP address can be assigned to each ONT, which exists in an IP address pool established for the ONT itself. The DHCP server 102 may establish the IP address pools according to the number of subscribers who will be assigned IP addresses. Also, it is possible that the IP address pools are established through the operator interface 106 by the operator.

When a subscriber host connected to an ONT 116 requests IP address assignment, for example, when the subscriber host wants to be connected to the Internet, the ONT 116 transmits an IP lease request message to the EPON DHCP server 102 (step 220). As described above, the ONT 116 assigns a null IP address in the IP lease request message, and outputs the IP lease request message with a host's hardware MAC address and a host name. The DHCP server 102 having received the IP lease request message from a host located in the ONT 116 searches for the ONT, using the MAC address of the host having requested an IP address as an index (step 230). Since the IP lease request message includes the hardware MAC address of the subscriber host having requested IP address assignment, the DHCP server 102 knows the hardware MAC address of the subscriber host from the received IP lease request message. The hardware MAC address of the subscriber host is known by the MAC processing section 104. The MAC processing section 104 has information of host MAC addresses according to ONTs. Therefore, the DHCP server 102 can search an ONT which includes the host having requested IP address assignment, using the information of host MAC addresses of respective ONTs which the MAC processing section 104 has. In step 240, the DHCP server 102 assigns the ONT having requested IP address assignment an available IP address existing in the IP address pool established for the ONT.

Such IP addresses are assigned to the subscriber hosts of each ONT till assignable IP addresses in the IP address pool established for the ONT itself have been all used. If there is no available IP address when a substrate host requests IP address assignment, the request of IP address assignment is rejected.

In step 250, the DHCP server 102 transmits an IP lease acknowledgment message, which includes an IP address assigned to the ONT 116, to the ONT 116. When the ONT 116 having received the IP lease acknowledgment message sends an acknowledgment response signal to the DHCP server 102 (step 260), the subscriber host is regarded as a bound DHCP client, so that it is possible to communicate by means of TCP/IP.

As described above in various embodiments above, since the DHCP server is contained in the OLT, the DHCP server can use information of each ONT which the OLT has, so that it is unnecessary to use a broadcasting method in an IP address assignment process, and the DHCP server can assign IP addresses to subscriber hosts according to the ONTs with ease.

While the invention has been shown and described with reference to certain various embodiments thereof, it will be understood by those skilled in the art that various changes in form and details may be made therein without departing from the spirit and scope of the invention as defined by the appended claims.

1. A method for assigning IP addresses in an Ethernet passive optical network which includes an OLT (Optical Line Terminal) and a plurality of ONTs (Optical Network Terminals) connected to the OLT, the method comprising the steps of:
including a dynamic host configuration protocol (DHCP) server in the OLT;
establishing IP address pools including at least one IP address according to the ONTs;
searching for an ONT from a MAC processing section of the OLT by means of a MAC address from which IP address assignment is requested when IP address assignment is requested from one of the ONTs, the ONT being connected to a DHCP client; and
assigning an available IP address existing in an IP address pool established for the ONT having requested the IP address assignment according to ONTs.

2. The method as claimed in claim 1, further comprising a step of transmitting a response signal from the ONT having requested IP address assignment to the DHCP server when the ONT is assigned an IP address from the DHCP server.

3. The method as claimed in claim 1, further comprising a step of rejecting the IP address assignment request in the DHCP server when there in no available IP address in the IP address pool established for the ONT having requested the IP address assignment.

4. The method as claimed in claim 1, further comprising the step of establishing the IP address pools according to a number of subscribers who will be assigned IP addresses.

5. The method as claimed in claim 1, further comprising the step of allowing an operator to establish the IP address pools through an operator interface.

6. An OLT (Optical Line Terminal) that is connectable to a plurality of ONTs (Optical Network Terminals) in an Ethernet passive optical network, comprising:
a dynamic host configuration protocol (DHCP) server;
a communication interface to the plurality of ONTs; and
a MAC processing section,
wherein the DHCP server is configured to search for an ONT from the MAC processing section using a MAC address from which an IP address assignment is requested when IP address assignment is requested from one of the plurality of ONTs through the communication interface.

7. The OLT as claimed in claim 6, further comprising an operator interface.

8. The OLT as claimed in claim 6, wherein the DHCP server includes an IP address pool including at least one IP address according to the plurality ONTs.

9. The OLT as claimed in claim 9, wherein the DHCP server is configured to assign an available IP address existing in the IP address pool established for the ONT having requested the IP address assignment according to ONTs.

10. An Ethernet passive optical network, comprising:
an OLT (Optical Line Terminal) including a dynamic host configuration protocol (DHCP) server in the OLT; and
a plurality of ONTs (Optical Network Terminals) connected to the OLT,
wherein the OLT includes means for establishing IP address pools including at least one IP address according to the ONTs, means for searching for an ONT from a MAC processing section of the OLT by means of a MAC address from which IP address assignment is requested when IP address assignment is requested from one of the ONTs, the ONT being connected to a DHCP client, and means for assigning an available IP address existing in an IP address pool established for the ONT having requested the IP address assignment according to ONTs.

11. The network as claimed in claim 10, wherein the OLT further comprises means for transmitting a response signal from the ONT having requested IP address assignment to the DHCP server when the ONT is assigned an IP address from the DHCP server.

12. The network as claimed in claim 10, wherein the OLT further comprises means for rejecting the IP address assignment request in the DHCP server when there in no available IP address in the IP address pool established for the ONT having requested the IP address assignment.
